(19) United States
(12) Patent Application Publication
(10) Pub. No.: US 2023/0196504 A1
(43) Pub. Date: Jun. 22, 2023

(54) AUGMENTED REALITY ALIGNMENT WITH A GLOBAL POSITIONING SYSTEM AND MOBILE DEVICE

(71) Applicant: Memery Inc., Portola Valley, CA (US)

(72) Inventor: Joshua Richau, Lafayette, CO (US)

(21) Appl. No.: 18/083,399

(22) Filed: Dec. 16, 2022

Related U.S. Application Data
(60) Provisional application No. 63/291,267, filed on Dec. 17, 2021.

(51) Int. Cl. G06T 3/00; G06T 11/00; G06F 3/0346

(52) U.S. Cl. CPC G06T 3/0068; G06T 11/00; G06F 3/0346

(57) ABSTRACT

Disclosed is a configuration that includes attaching a global positioning system (GPS) device to a mobile device in a fixed alignment. An augmented reality (AR) session is started on the mobile device. An initialization point for the two devices is obtained and set as a zero reference point. The mobile device stores timestamped pose, or six degrees of freedom (6 DoF), measurements corresponding with the device's orientation. The GPS device sends coordinate measurements corresponding to the device's location in the world. Using both timestamped pose measurements and timestamped GPS coordinates, the mobile device generates pairs of pose measurements and GPS coordinates. The mobile device aligns the AR coordinate system and the GPS coordinate system. Based on the aligned coordinate systems, graphics rendered for display in the AR landscape are corrected to be earth-aligned as the devices move.

### CROSS REFERENCE TO RELATED APPLICATIONS

This application claims the benefit of U.S. Provisional Application No. 63/291,267 filed Dec. 17, 2021, which is hereby incorporated in its entirety by reference.

### TECHNICAL FIELD

The disclosure generally relates to the field of augmented reality and, more specifically, creating a virtual environment that is earth-aligned as a user moves and the real-world environment changes.

### BACKGROUND

Augmented reality (AR) allows users to view their real-world surroundings intermixed with graphic renderings. Users move around in a virtual space containing multiple virtual graphics that are positioned to appear as part of the world. Aligning AR views within a physical view (an AR scene) on a mobile screen is, however, not seamless. For example, a problem that arises when the user moves around in the virtual space the rendered graphics no longer align with the real-world environment. This phenomenon may be called “drift.” Drift occurs due to movement of objects in the environment relative to what is displayed, such as cars, leaves falling from trees, or people entering and exiting the space. Weather occurrences such as snow or heavy rain also dramatically change the AR landscape. These moving parts cause the AR system to lose track of where rendered graphics should be positioned in relation to the real world.

To address the issue of drift, systems rely on predetermined anchor points. For example, a certain bench is recognized as the spot where a cartoon bird is rendered. As a user moves, the bench is an anchor point for the system to recognize and correct the location of the graphics. This strategy, however, can lead to jumpiness within the AR scene. The system will drift, and then jump to correct itself when the bench is again recognized. This jump creates a disjointed view for users and can be mistaken if the system falsely identifies an anchor point in an incorrect location.

Hence, there is lacking, inter alia, an alignment configuration for an AR scene that can continuously correct for drift as a user moves.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates an example of an environment with a mobile device and global positioning system (GPS) device in accordance with an embodiment.

FIG. 2 illustrates an example software architecture of the mobile device in accordance with one embodiment.

FIG. 3 illustrates a flowchart depicting an example process for adjusting graphics based on aligned coordinates from the GPS device and pose from the mobile device according to one embodiment.

FIG. 4 illustrates a graph showing an offset of the GPS device measurements and the augmented reality (AR) session on the mobile device from the alignment point in accordance with one embodiment.

FIG. 5 illustrates unaligned coordinate systems for the GPS device and the AR session on the mobile device in accordance with one embodiment.

FIG. 6 illustrates the frame alignment of measurements from the GPS device and AR frames from the AR session on the mobile device in accordance with one embodiment.

FIG. 7 illustrates a flowchart depicting an example process for adjusting graphics by applying corrections to an aligned coordinate system, in accordance with one embodiment.

FIG. 8 is a diagram of an example computing device architecture in accordance with one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes a mobile device in an established alignment with a global positioning system (GPS) device. Established alignment means that the distance and configuration between the GPS device and mobile device does not change during an augmented reality (AR) session. The mobile device initiates an AR landscape and displays an AR scene to a user. After initiating the AR landscape, the mobile device stores pose, or six degrees of freedom (x, y, z, roll, pitch, and yaw), measurements as the user moves. The GPS device sends timestamped coordinate measurements to the mobile device. The GPS coordinates are matched with a timestamped pose measurement that is closest to the GPS coordinate timestamp. The matched measurements are aligned. The aligned pose measurement and GPS coordinate measurement are used to adjust graphics for display in the AR landscape, preventing drift of the AR landscape.

Figure (FIG. 1 depicts one embodiment of an environment having a mobile device 130 and GPS 110 device in accordance with an embodiment. The environment includes a network 105, the GPS device 110, and a mobile device 130. The environment also may include a handle 140 and a stem 120, both of which may be optional. The mobile device 130 and the GPS 110 are communicatively coupled, e.g., in communication via wireless link such as BLUETOOTH. The mobile device 120 is communicatively coupled with a network 105, e.g., which may be a cloud service having a wireless communication such as WiFi, cellular, or a combination thereof. The GPS 110 also may couple with a GPS system. The mobile device 130 may be rigidly coupled with the GPS 110 using, for example, a handle 140 coupled with the mobile device 130 and stem 120 coupled with the GPS device 110. Examples for other ways the mobile device 130 and GPS device 110 may be rigidly coupled include a gimbal assembly onto which both devices are fixably coupled. In another example, the GPS device 110 and mobile device 130 may be rigidly coupled with an extendable arm structure on which the both the GPS device 110 and the mobile device 130 are fixably coupled.

The rigid connection between the mobile device 130 and the GPS device 110 maintains a relatively fixed alignment of the devices 110, 130 as they are moved around. The GPS device 110 may use the network 105 to communicate with a cloud service and provide GPS coordinates for the mobile device 130. Alternatively, the GPS device 110 may use the network 105 to communicate directly with the mobile device 130, for example through a BLUETOOTH connection. The external cloud service may provide external corrections that allow the GPS device 110 to improve accuracy of delivered coordinates. Alternately, the GPS coordinates (with timestamp) may be directly provided to mobile device 130 from the GPS device 110 (e.g., via a BLUETOOTH connection) and simultaneously those coordinates (with a timestamp) may be provided (e.g., via the network 104 and WiFi or cellular connection) to the cloud service for logging.

A user (individual or device such as a vehicle or robotic instrument) may secure (e.g., hold or attach to) the handle 140 as they move about an AR landscape so that the GPS device 110 and mobile device 130 remain in the same configuration. In other embodiments, the GPS device 110 and the mobile device 130 are in established alignment with an alternative attachment mechanism that maintains a constant distance and position between the two devices as the user moves.

### System Architecture

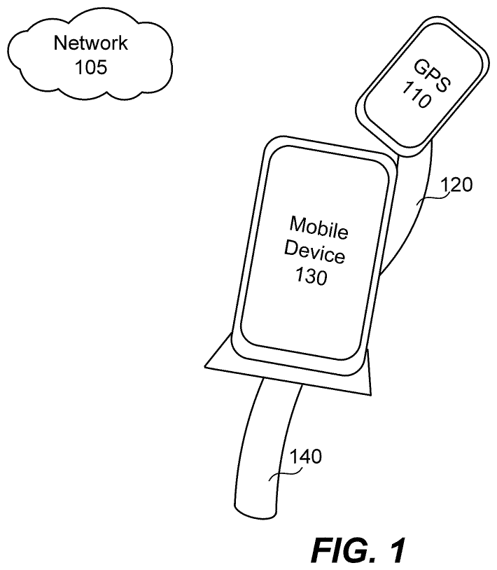

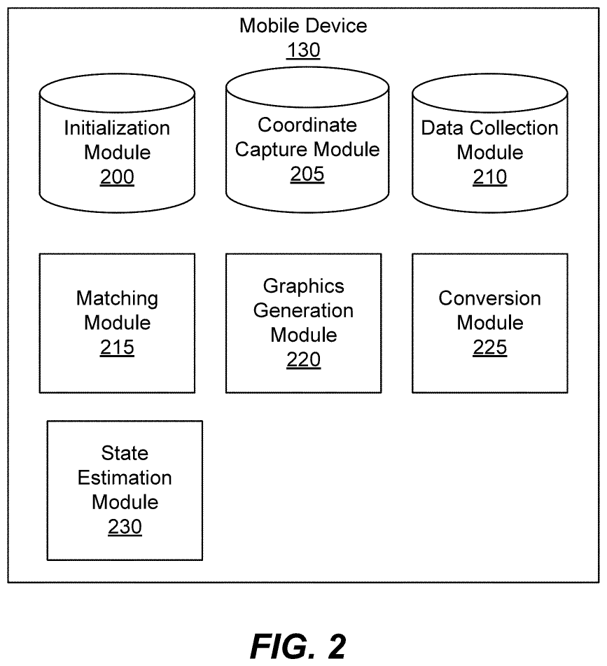

FIG. 2 illustrates an example mobile device software architecture according to one embodiment. The mobile device 130 stores multiple modules. The modules are used to run the AR session and keep the scene earth-aligned. The architecture includes an initialization module 200, a coordinate capture module 205, a data collection module 210, a matching module 215, a graphics generation module 220, a conversion module 225, and a state estimation module 230.

The initialization module 200 is configured to orient an AR landscape by establishing a shared zero reference point for both the augmented reality coordinate system (ARCS) and the GPS coordinate system (GPSCS). The AR landscape may initialize when the user starts an AR session on the mobile device 130. According to some embodiments, the initialization module 200 sets a first initialization point for the user based on measurements at the time that the AR session is started. Then, the mobile device 130 and the GPS device 110 are determined to be moving together based on the location and movement of the two devices. Once the two devices 110, 130 are determined to be moving together, the initialization module 200 sets a shared zero point for the AR landscape. The shared zero is used as an initialization point for reference in the AR session as the user moves. Corrections can be calculated from the zero reference point for both the GPSCS and ARCS.

The coordinate capture module 205 is configured to obtain (or captures) coordinates from the GPS device 110 and pose from the mobile device 130. The coordinate capture module 205 communicates, e.g., via BLUETOOTH, with the GPS device 110. GPS coordinate measurements are sent to the mobile device 130 through the coordinate capture module 205, where the measurements are timestamped and sent to the data collection module 210. Pose from the mobile device 130 is also timestamped and collected in the data collection module 210.

Pose measurements from the mobile device 130 may include six degrees of freedom (6 DoF) measurements including Cartesian coordinates as well as axis of rotation (roll, pitch, and yaw) associated with movement of the mobile device 130 within a special area. Pose measurements are captured with timestamps in the data collection module at a set frequency. The data collection module 210 additionally captures GPS coordinate measurements that are timestamped. GPS coordinate measurements are collected at a frequency that is lower than the pose measurements, in some embodiments.

From the data collection module 210, data is sent to the matching module 215. Due to differing frequencies of capture for each device, the measurements are captured with timestamps in the data collection module 210. Then, when a coordinate measurement from the GPS device 110 is received, the matching module 215 takes the closest timestamped pose measurement to match with the GPS coordinate measurement. In some embodiments, the matching module 215 identifies the two closest timestamped pose measurements and selects one of the pose measurements that is closest to the GPS coordinate timestamp.

The mobile device 130 additionally contains a graphics generation module 220. The graphics generation module 220 provides for rendering of graphics onto a display, e.g., on or connected with the mobile device. The graphics generation module 220 provides for rendering of graphics that are associated with the location and position of the mobile device 130.

The conversion module 225 is configured to convert GPS coordinate measurements from degrees to meters. Calculations to orient the AR landscape may be metric, e.g., meters, or English, e.g., feet, measurement systems. The conversion module converts GPS coordinates from degrees to meters from the initialization point or from a reference point. In some embodiments, GPS coordinate measurements are converted to Universal Transverse Mercator (UTM) coordinates. GPS coordinates are then converted back to degrees for storage in the data collection module 210.

The state estimator module 230 is configured to calculate an offset and an angle value (e.g., theta) for the GPSCS and ARCS. In some embodiments, the state estimator module handles the primary variables that cause drift—horizontal (x, z) and angle (theta). This entails calculating the offset between incoming ARCS (x, z) and GPSCS (x, z). The state estimator maintains a state that is (x, z, theta, Lat0, Lon0). The angle value, theta, along with coordinate values, Lat0, and Lon0, represent the calculated correction to keep the GPSCS and ARCS aligned. The state estimator generates a confidence estimate for a calculated correction. The confidence estimate can be based on a Mahalanobis distance. As the confidence declines, it may indicate a problem with GPS accuracy or catastrophic AR failure (e.g. a sensor failure) in the system that, in turn, may involve issuing a user warning that the AR landscape is misaligned. This user warning allows for a graceful failure mode (preventing further reliance on the alignment) until such time as the subsystems can recover and proper alignment can be reestablished. Adjusting and restabilizing the alignment requires subsequent GPS coordinate and pose measurements to reorient the two devices within the AR landscape. The decision whether to apply a calculated correction can be based on a predetermined confidence threshold value. Using a confidence calculation to determine whether to apply calculated corrections prevents jumpiness in the AR system or false corrections in the user's view. In some embodiments, elevation smoothing is used. In some embodiments, a second hidden variable of calculated velocity is used to predict where an object will end up. I some embodiments, the GPS device 110 is not a separate device from the mobile device 130. The GPS device 110 may be connected to the mobile device 130. The GPS device 110 may communicate with the mobile device 130 through a bus line between the processor of the mobile device 130 and the GPS device 110. In embodiments where the GPS device 110 is connected to the mobile device 130, the embodiment accordingly operates as denoted above.

### Example System

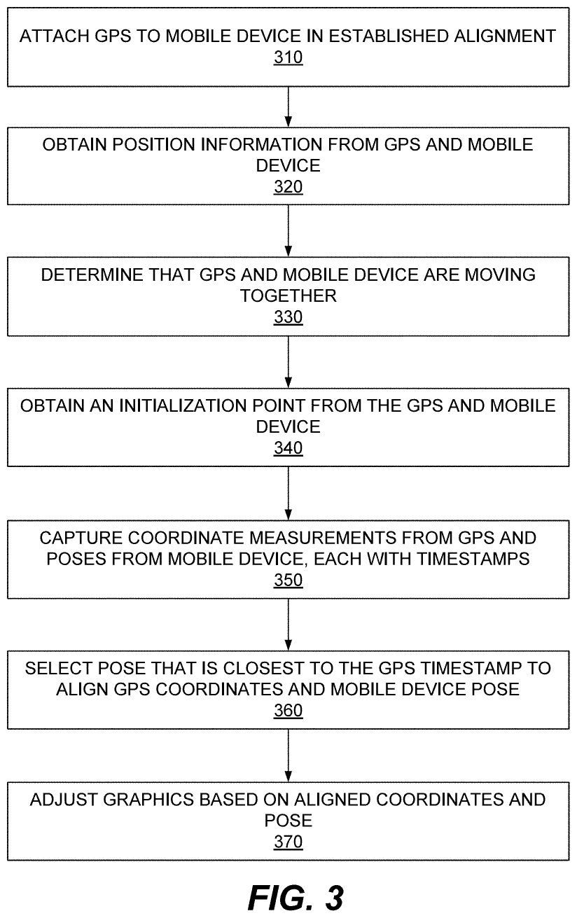

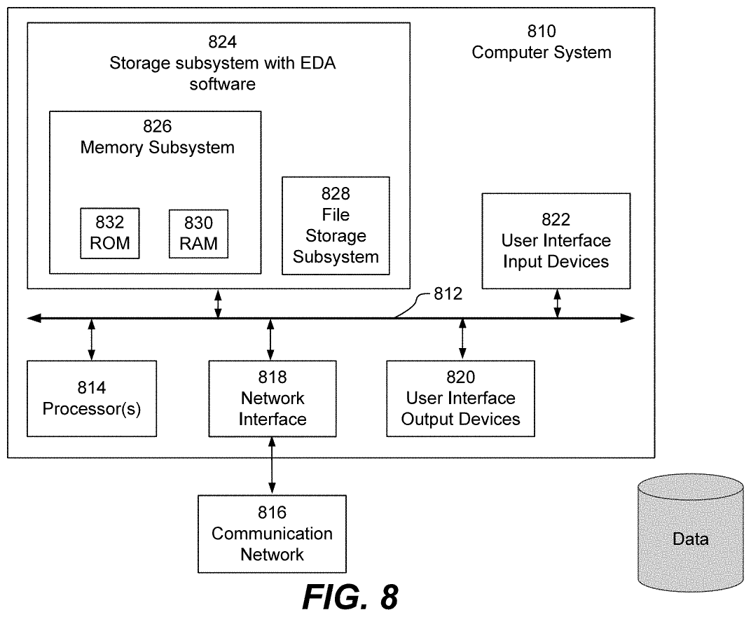

FIG. 3 illustrates a flowchart depicting an example process 300 for adjusting graphics based on aligned coordinates from the GPS device and pose from the mobile device according to one embodiment. The process may be embodied as computer readable instructions and may be operated with the architecture of the mobile device 130 of FIG. 2 and further may operate on a mobile device 130 having some or all of the components of an example machine (e.g., computer system) as is further described in FIG. 8.

In step 310, a GPS device 110 is attached in established alignment to a mobile device 130. The attachment may be a relative physical connection to ensure the two devices 110, 130 remain consistently positioned relative to each other. In some embodiments, the established alignment is created and maintained using a handle 140 and stem 120. In some embodiments, the established alignment is created and maintained by attaching the devices at a constant distance and configuration. For example, the mobile device 130 may be attached to a first end of a rod or slab and the GPS device 110 may be attached to a second end of the rod or slab. In some embodiments, the GPS device 110 is a precision GPS device.

In step 320 of the system 300, position information is obtained from the GPS device 110 and the mobile device 130. Using the coordinate capture module 205, mobile device 130 obtains GPS coordinate measurements from the GPS device 110 via the network 105.

In step 330 of, the GPS device 110 and mobile device 130 are determined to be moving together. The devices may be determined to be moving together by the initialization module 200 setting a first initialization point when the AR session begins. As the two devices 110, 130 move away from the reference point at a similar distance, it is apparent that the devices 110 and 130 are together. Specifically, initial recognition of the devices 110, 130 being attached is performed by obtaining g an AR/GPS data pair and looking at the subsequent pairs of points. The subsequent pairs of points are analyzed with an expectation for the pairs to meet certain criteria. In some embodiments, the criteria can be that a geometric distance between two AR datapoints and a geometric distance between two GPS datapoints that may be within a few centimeters of one another, while the distance between the datapoint pairs may be more than a meter apart. In other embodiments, the criteria threshold for distances between datapoints and pairs of datapoints are configurable. Once the devices are determined to be moving together, an initialization point is obtained at step 340. The initialization point is a zero point that is used as a reference for the AR session. Both the GPSCS and ARCS share a zero point as a reference point, in accordance with some embodiments. The conversion module 225 later uses the reference point to convert GPS coordinates from degrees to meters from the reference point.

Step 350 may entail capturing coordinates from the GPS device 110 and poses from the mobile device 130. As the GPS coordinates and mobile device pose are stored in the data collection module 210, they are timestamped with a time of capture. In step 360, a pose from the mobile device 130 is selected based on proximity to the GPS timestamp. The matching module 215 selects candidate pose frames from the data collection module based on the proximity of their timestamps to a GPS coordinate timestamp.

In step 370, graphics data may be adjusted based on aligned GPS coordinates and mobile device pose. GPS coordinate measurements include a latitude, longitude, and elevation. The conversion module 225 converts the latitude and longitude measurements from degrees to meters from the reference point for calculations. Graphics data may be adjusted using the state estimation module 230 to calculate offset. The graphics data may be used to provide graphics for display on a screen associated with a computing device, e.g., the mobile device 130.

### State Estimator

Referring briefly to FIG. 2, the state estimator 230 manages position information, (x, z), as well as offset between the GPSCS and ARCS-θ, Lat0, Lat0, Lon0. A measured state “mk” is equal to these managed position variables at a “k” point in time. Measurement noise, R, is calculated based on the combined error of each variable. For AR measurements 430, 0.1 may be used as it may be rare to have drift more than 0.1 between readings. Theta 420 has an error of 0.1 in some embodiments. GPS latitude and longitude 410 have a variable error value that is provided by a horizontal accuracy (hacc) provided by the GPS device. Process noise, Q, is separate from measurement error and assumes that the GPS is very accurate and that AR measurements slip more. These values are empirically tuned based on the AR system and GPS system with one embodiment being for example AR (X, Z): 0.3, theta: 0.001, GPS: 0.01.

Previous uncertainties based on measurement noise, R, and process noise, Q, are added to process noise. For the theta calculation, a Jacobian is used to handle the inherent non-linearity of the angle. A prediction may be made and compared to incoming measurements. Based on that comparison, a gain, K, is calculated and added to the prediction.

Continuing, a Mahalanobis distance (d) of innovation is calculated, if the distance of innovation is determined to be reasonable (below a pre-defined threshold), the changes will be applied. In some embodiments, a threshold of d<1 can be used to determine whether to apply calculated changes to the AR scene. If it is too large, the calculated offsets are not used and the system waits for the next set of measurements. Additionally, this confidence is provided such that the end user can be provided feedback. The offset and theta of the new state are provided to the AR system to update the geodetically stabilized coordinate system and subsequent graphics data for rendering in it.

### Alignment of Two Coordinate Systems

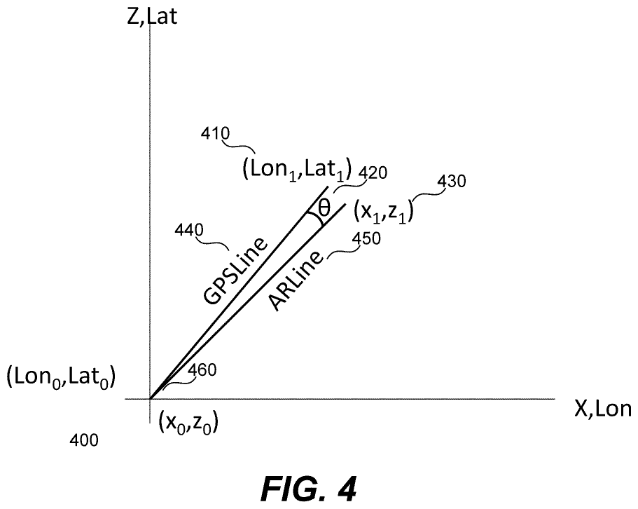

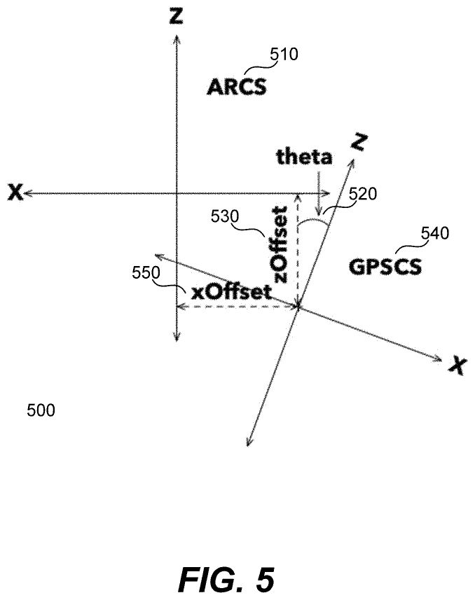

Referring now to FIG. 4 and FIG. 5, alignment of two disparate coordinate systems, AR coordinate system (ARCS) and GPS coordinate system (GPSCS), is illustrated. FIG. 4 depicts the GPSLine 440 and ARLine 450, indicating the displacement of the mobile device 130 and GPS device 110 from the zero reference point, (Lon0, Lat0) and (x0, z0). The 2 point angle estimator 230 determines that the length of GPSLine 440 is sufficiently long (above a threshold value that may be predetermined, e.g., one meter), and the ARLine is equal to the GPSLine in length (within a similarity threshold value). If the length of the lines is equal and sufficiently long, then theta 420 is calculated as the current offset between the two coordinate systems. This theta is then provided to the state estimator when available.

Referring to FIG. 5, the two coordinate systems that will be aligned are shown. In this diagram, the GPSCS 540 is shown as offset from the ARCS 510 at an offset angle 520. The state estimator 230 determines the zOffset 530 and xOffset 550 to align the origins of the coordinate systems. The angle theta 520 is determined to align the orientations of the two disparate coordinate systems 510, 540.

### Frame Matching Between ARCS and GPSCS

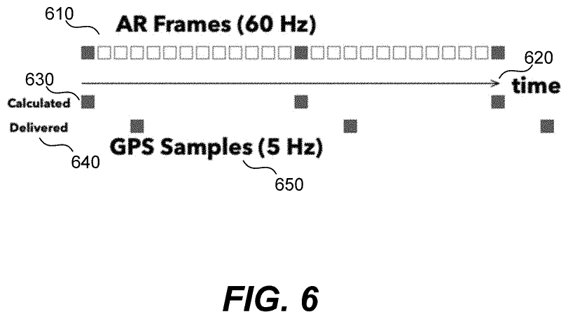

As previously noted, the mobile device 130 contains a matching module 215. The matching module 215 creates pairs of GPS coordinates and pose measurements from the mobile device 130. In some instances, GPS device 110 and mobile device 130 may have different sampling frequencies. Referring to FIG. 6, it illustrates the frame alignment of measurements from the GPS device and AR frames from the AR session on the mobile device in accordance with one embodiment. Here, the GPS device 110 has a lower sampling frequency than the AR on the mobile device 130. In this example, the GPS device transmits fewer coordinate measurements than the mobile device transmits pose measurements.

To resolve the disparity in frequencies, FIG. 6 helps illustrates operation of the matching module 215. The mobile device 130 provides pose measurements, represented in FIG. 6 as “AR Frames” 610. In this embodiment, the pose measurements are delivered at a 60 Hz frequency. In contrast, the GPS coordinate measurements 650 are sampled at a lower, 5 Hz frequency. In addition to the GPS coordinates having a lower sampling frequency, the GPS system has a processing and delivery delay. Delivered GPS coordinate measurements 640 arrive with a timestamp from the time of capture for the measurements. Because the AR pose frames 610 are stored with timestamps in the data collection module 210, the matching module 215 can “look back” into the stored AR pose frames to find a pose frame with a closest timestamp to a delivered GPS measurement. This matching process generates pairs of AR frames 610 and calculated GPS measurements 630 that correspond to the same time of capture. Pairs of matching AR frames and GPS measurements are shown as shaded boxes in the row 610 and as the calculated GPS samples row 630. As an AR session proceeds through time, this matching process continuously pairs GPS coordinates with AR frames from the mobile device 130 over time 620.

### Example System Overview

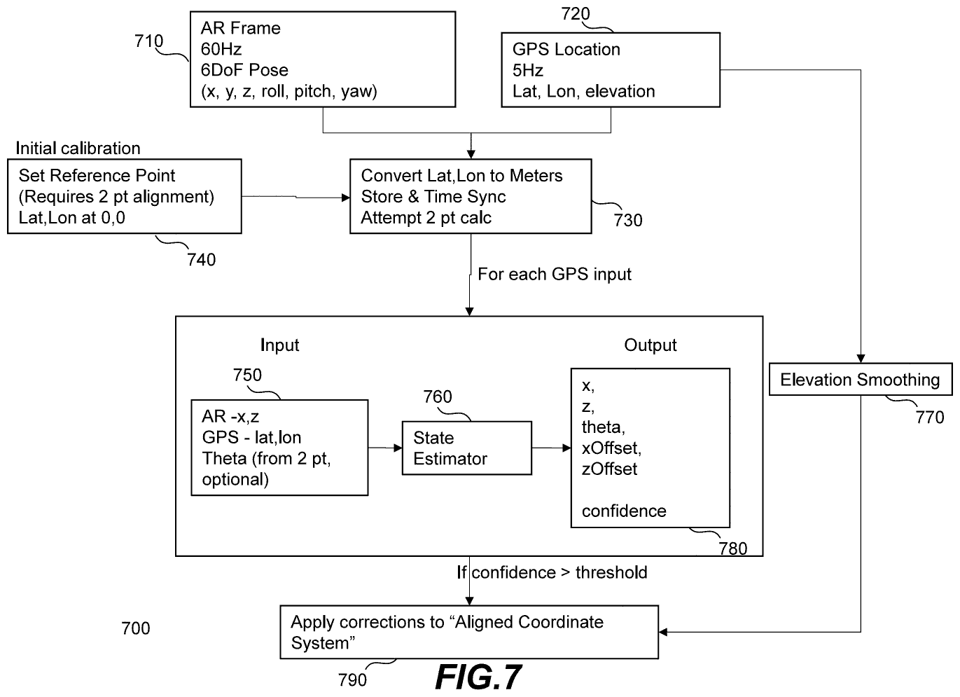

FIG. 7 depicts an example system overview 700. The system 700 has two main system inputs, 710 and 720. Input 710 corresponds to the mobile device 130. The mobile device 130 generates input 710, which includes AR frame at a frequency of 60 Hz with 6 DoF pose information (x, y, z, roll, pitch, and yaw). Input 720 corresponds to the GPS device 110. The GPS device generates a GPS location at a 5 Hz that includes latitude, longitude, and elevation.

The initialization module 200 performs step 740 of the example process 700. A reference point is set as an initialization point when the two devices are determined to be moving together. The GPS coordinates and AR frame at the reference point are aligned using a two-point alignment. The AR session sets this as the origin for reference to correct back to as the devices are moved.

Step 730 of the example process 700 is directed to managing the input data 710 and 720. The conversion module 225 converts latitude and longitude from the GPS coordinate measurements into meters. The GPS coordinate measurements along with timestamps corresponding to the time of the coordinate's capture are stored in the data collection module 210. Mobile device AR frames and their timestamps are stored in the data collection module 210, as well. The matching module 215 is used to generate pairs of GPS coordinate measurements and AR pose frames using, for example, the process described in FIG. 6. A two-point calculation to determine the theta offset between the two coordinate systems is performed.

Step 750 of the example process 700 depicts the inputs to the state estimator module 230. From pose measurements, x and z coordinates are input. From GPS coordinate measurements, latitude and longitude measurements are input. Optionally, theta offset is input to the state estimator if there is a valid result from the 2 point calculation. Step 760 is directed to the state estimator module 230. The output 780 of the state estimator is a state estimate including (x, z, 0, xOffset, zOffset). A confidence estimate for the output state estimate 780 is given that determines whether corrections will be applied to the AR landscape in step 790. Additionally, in applying corrections in step 790, thresholding can be applied to corrections to prevent them from being visually jarring on the display. For example, a limit of 5 centimeters can be applied so that the corrected scene does not jump by too much and create a jarring effect for the display.

A step 770 provides elevation smoothing for the AR landscape as the two devices move. Less drift is experienced with elevation such that the state estimator may maintain an offset between the GPS elevation information and the AR elevation information. This can be a long-term smoothing filter to prevent elevation drift. In some embodiments, the dynamic vertical noise estimate for GPS can be leveraged to modify the elevation smoothing.

### Computing Machine Architecture

FIG. (FIG. 8 is a block diagram illustrating components of an example machine structured to read program code from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed, for example as describe with FIGS. 2-7. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors 802 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 804, and a static memory 806, which are configured to communicate with each other via a bus 808. The computer system 800 may further include visual display interface 810. The visual interface may include a software driver that enables (or provide) user interfaces to render on a screen either directly or indirectly. The visual interface 810 may interface with a touch enabled screen. The computer system 800 may also include input devices 812 (e.g., a keyboard a mouse), a storage unit 816, a signal generation device 818 (e.g., a microphone and/or speaker), and a network interface device 820, which also are configured to communicate via the bus 808.

The storage unit 816 includes a machine-readable medium 822 (e.g., magnetic disk or solid-state memory) on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution.

### ADDITIONAL CONFIGURATION CONSIDERATIONS

The disclosed configurations advantageously aligns the pose of a mobile device with the coordinate measurements of a separate GPS device, while the two devices are in an established alignment relative to each other. By aligning the GPS coordinates with the mobile device pose, the AR session can be earth-aligned and prevent drift of the AR landscape. Internal compasses and GPS capabilities in a mobile device are not as accurate as a high precision, external GPS. At times, a mobile device will not recognize where it is in the world (e.g., San Francisco versus Los Angeles). This creates a problem when an AR landscape is supposed to be earth-aligned with the user's environment. GPS devices are good at recognizing a location in the world. Therefore, aligning the location measurements of the mobile device and separate GPS device in order to keep an AR landscape earth-aligned is an improvement to AR.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for aligning a GPS coordinate system and an AR coordinate system using two separate devices in established alignment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
attaching a global positioning system (GPS) device to a mobile device in an established alignment, the GPS device being separate from the mobile device;
obtaining position information for the GPS device and for the mobile device;
determining that the GPS device and mobile device are moving together;
obtaining an initialization point from the GPS device and the mobile device in response to a determined movement together;
capturing a coordinate measurement and a GPS timestamp from the GPS device and a plurality of poses from the mobile device and a mobile device timestamp for each pose after the initialization point, the coordinate measurements from the GPS device and the pose from the mobile device occurring at differing frequencies for each device, wherein the poses comprise six degrees of freedom;
selecting a pose of the plurality of poses that is closest in time to the GPS timestamp to align the coordinates of the GPS and the pose of the mobile device; and
adjusting graphics for display with the aligned coordinates of the GPS and the pose of the mobile device.

2. The method of claim 1, wherein the pose from the mobile device comprises X, Y, Z Cartesian coordinates and an axis of rotation corresponding to pitch, roll, and yaw.

3. The method of claim 1, wherein the GPS device is a separate device from the mobile device.

4. The method of claim 1, wherein obtaining an initialization point further comprises determining a theta offset between the pose of the mobile device and the coordinate measurements from the GPS device.

5. The method of claim 1, wherein matching the captured measurements further comprises:
converting the GPS measurements from degrees to meters from the initialization point; and
converting the GPS measurements in meters back to degrees for storage.

6. The method of claim 1, wherein matching the captured measurements further comprises:
identifying two pose frames closest to the time of capture for the GPS coordinate; and
selecting one pose frame out of the two pose frames that is closest in location and time to the GPS coordinate.

7. The method of claim 1, wherein adjusting the graphics further comprises:
calculating a confidence estimate for corrections being applied to the graphics; and
determining based on a threshold confidence whether to apply the corrections.

8. The method of claim 1, wherein adjusting the graphics further comprises:
applying threshold limitations to correcting locations of rendered graphics.

9. A computer readable medium configured to store instructions, the instructions when executed by a processor cause the processor to:
attach a global positioning system (GPS) device to a mobile device in an established alignment, the GPS device being separate from the mobile device;
obtain position information for the GPS device and for the mobile device;
determine that the GPS device and mobile device are moving together;
obtain an initialization point from the GPS device and the mobile device in response to a determined movement together;
capture a coordinate measurement and a GPS timestamp from the GPS device and a plurality of poses from the mobile device and a mobile device timestamp for each pose after the initialization point, the coordinate measurements from the GPS device and the pose from the mobile device occurring at differing frequencies for each device, wherein the poses comprise six degrees of freedom;
select a pose of the plurality of poses that is closest in time to the GPS timestamp to align the coordinates of the GPS and the pose of the mobile device; and
adjust graphics for display with the aligned coordinates of the GPS and the pose of the mobile device.

10. The method of claim 8, wherein the pose from the mobile device comprises X, Y, Z Cartesian coordinates and an axis of rotation corresponding to pitch, roll, and yaw.

11. The method of claim 8, wherein obtaining an initialization point further comprises determining a theta offset between the pose of the mobile device and the coordinate measurements from the GPS.

12. The method of claim 8, wherein matching the captured measurements further comprises:
converting the GPS measurements from degrees to meters from the initialization point; and
converting the GPS measurements in meters back to degrees for storage.

13. The method of claim 8, wherein matching the captured measurements further comprises:
identifying two pose frames closest to the time of capture for the GPS coordinate; and
selecting one pose frame out of the two pose frames that is closest in location and time to the GPS coordinate.

14. The method of claim 8, wherein adjusting the graphics continuously further comprises:
calculating a confidence estimate for corrections being applied to the graphics; and
determining based on a threshold confidence whether to apply the corrections.

15. The method of claim 8, wherein adjusting the graphics further comprises:
applying threshold limitations to correcting the locations of rendered graphics.

16. A system comprising a mobile device and a separate GPS device in established alignment, wherein the mobile device is configured to:
obtain position information for the GPS device and for the mobile device;
determine that the GPS device and mobile device are moving together;
obtain an initialization point from the GPS device and the mobile device in response to a determined movement together;
capture a coordinate measurement and a GPS timestamp from the GPS device and a plurality of poses from the mobile device and a mobile device timestamp for each pose after the initialization point, the coordinate measurements from the GPS device and the pose from the mobile device occurring at differing frequencies for each device, wherein the poses comprise six degrees of freedom;
select a pose of the plurality of poses that is closest in time to the GPS timestamp to align the coordinates of the GPS and the pose of the mobile device; and
adjust graphics for display with the aligned coordinates of the GPS and the pose of the mobile device.

17. The method of claim 15, wherein obtaining an initialization point further comprises determining a theta offset between the pose of the mobile device and the coordinate measurements from the GPS.

18. The method of claim 15, wherein matching the captured measurements further comprises:
converting the GPS measurements from degrees to meters from the initialization point; and
converting the GPS measurements in meters back to degrees for storage.

19. The method of claim 15, wherein matching the captured measurements further comprises:
identifying two pose frames closest to the time of capture for the GPS coordinate; and
selecting one pose frame out of the two pose frames that is closest in location and time to the GPS coordinate.

20. The method of claim 15, wherein adjusting the graphics continuously further comprises:
calculating a confidence estimate for corrections being applied to the graphics; and
determining based on a threshold confidence whether to apply the corrections.
